(19) United States
(12) Patent Application Publication
(10) Pub. No.: US 2011/0258272 A1
(43) Pub. Date: Oct. 20, 2011

(54) FACILITATING TRANSMISSION OF AN EMAIL OF A WELL BEHAVED SENDER BY EXTRACTING EMAIL PARAMETERS AND QUERYING A DATABASE

(75) Inventors: DEAN DRAKO, LOS ALTOS, CA (US); ZACHARY LEVOW, MOUNTAIN VIEW, CA (US)

(73) Assignee: BARRACUDA NETWORKS INC., CAMPBELL, CA (US)

(21) Appl. No.: 13/153,327

(22) Filed: Jun. 3, 2011

Related U.S. Application Data
(63) Continuation-in-part of application No. 12/167,547, filed on Jul. 3, 2008, now Pat. No. 7,996,475.

(51) Int. Cl. G06F 15/16

(52) U.S. Cl. 709/206

(57) ABSTRACT

Facilitating email transmission by extracting email parameters, requesting data in the form of a dns query, and receiving a sender reputation as an IP address. Querying a database by sending a plurality of arguments concatenated to a dns request and receiving an IP address in reply. Filtering email by querying a database with email parameters comprising an IP address and a domain of an email sender which may be extracted from an packet headers in the SMTP sequence up to and including the MAIL command and prior to the DATA command. The smtp session is continued, modified or interrupted according to the result of the query submitted to a database operating as a dns server.

### RELATED AND CO-PENDING APPLICATIONS

The present application is a continuation in part of application Ser. No. 12/167,547 filed Jul. 3-2008 “FACILITATING TRANSMISSION OF EMAIL BY CHECKING EMAIL PARAMETERS WITH A DATABASE OF WELL BEHAVED SENDERS” which issued as U.S. Pat. No. ______ on ______ which is incorporated by reference in its entirety. The present application claims priority from the above mentioned application filing date.

### TECHNICAL FIELD

The field of the invention is Internet based database operations and an application to facilitating the transmission of email. TABLE-US-00002 Definition List 1 Term Definition Email parameter A text string which is either part of an argument of a mail protocol command or a component of a TCP packet header connecting between email servers. Not limited to but includes IP addresses and domain names. The present application defines and uses this term. IP address An internet protocol (IP) address is e.g. 151.207.245.67 defined in RFC-791 IPv4 standard of the Internet Engineering Task Force. RFC-791 defines a replacement IPv6. Domain name Defined in RFC-1034, 1035, 1085, a e.g. www.uspto.gov domain name is a memorable host name that stands in for a numeric IP address. DNS Domain Name System defined in RFC 1035, includes resolvers and servers which respond to questions about domain names. The most basic task of DNS is to translate hostnames to IP addresses. The Domain Name System consists of a hierarchical set of DNS servers. SMTP Simple Mail Transfer Protocol documented in RFC 2821 DNSBL DNSBL is an abbreviation that usually stands for “DNS blacklist”. Typically entails a domain, a nameserver for that domain, and a list of addresses to publish. Generally returns either an address, indicating that the client is listed; or an “NXDOMAIN” (“No such domain”) code. DNSBL provides resources to support blocking spam. Fully qualified domain A fully qualified domain name has at name least a host and domain name, including top-level domain. A FQDN always starts with a host name and continues all the way up to the top-level domain name and includes intermediate level domains to provide an unambiguous path which specifies the exact location of a host in the Domain Name System's tree hierarchy through to a top-level domain

### SMTP Background

The simple mail transfer protocol (smtp) standardized as RFC2821, is widely used in most stages of delivering e-mail across the internet. The smtp protocol is built on the TCP or transmission control protocol discussed in RFC1180, and consists of commands, code, parameters, and data exchanged between clients and servers. A TCP service transmits packets whose headers contain the internet protocol (IP) address of the sending host and the receiving host.

Although the SMTP protocol provides for relay through a serial chain of clients and servers, in practice today, the sender client makes a direct connection to the receiver's server. Thus the IP header used to establish the handshake cannot be forged.

The envelope sender email address (sometimes also called the return-path) is used during the transport of the message from mail server to mail server, e.g. to return the message to the sender in the case of a delivery failure. It is usually not displayed to the user by mail programs.

The header sender address of an e-mail message is contained in the “From” or “Sender” header and is what is displayed to the user by mail programs. Generally, mail servers do not care about the header sender address when delivering a message. Spammers can easily forge these.

Thus it can be appreciated that what is needed is an efficient way to query a database from anywhere in the Internet, a high performance cachable storage of data which can reply to such queries, and a better way to look up the IP addresses of legitimate email senders so that their email can easily bypass filters. In more general terms, what is needed is a better way to distinguish legitimate email senders from spammers so that their email is efficiently delivered with less latency and resource consumption.

### SUMMARY OF THE SOLUTION

An application of a query—operation method is disclosed for facilitating the transmission of email.

The invention comprises a method for querying a remote database on the internet located at a domain name, the method comprising the steps following: appending a suffix containing the domain name to a first query argument; prepending a second query argument as a prefix to the first query argument; and sending a dns query to a dns resolver comprising questiontype=A, questionname=the fully qualified domain name, and questionclass=IN wherein prepending and appending includes inserting a delimiter to form a fully qualified domain name. The invention further comprises appending at least one query argument to the fully qualified domain name. The invention further comprises appending an authentication code as a query argument whereby a database can track and control access.

The invention comprises a method for operating a database comprising the steps of transmitting an IP address to a sender of a dns query; receiving a fully qualified domain name as the query name in a dns query from a dns client; and determining a first query argument and a second query argument from the fully qualified domain name.

The present invention selects email from legitimate senders and facilitates its transmission to receivers more efficiently while reducing the load on spam scanners. The method comprises: querying a database with a set of email parameters, and transmitting email according to the result of the query. The method further comprises transmitting the set of email parameters as concatenated labels in a string. The method further comprises extracting the email parameters by analyzing a TCP/IP header and an MAIL “FROM” command from an email envelope where the email parameters comprise at least an IP address of a client and a sender which is at least one of a local-part and a domain. In other words, the argument of the MAIL “FROM” command correctly includes <local-part@domain>. The set of email parameters comprises “domain” and “IP address”. It may further comprise “local-part”.

In an embodiment, the query comprises the step of an RBL-style lookup over the domain name system (DNS). However the content of the query is at least the domain of the email sender concatenated to the IP address of the client sending the MAIL “FROM” command. The domain or the entire email address is extracted from the argument of the MAIL “FROM” command. The method of the invention further comprises continuing the session to transfer the message body only if the reply from the reputation server determines the sender is not a spammer. In one embodiment, the database holds information on senders whose history does not include spam. In another embodiment, the email is transferred to an email filter for further analysis. In an alternate embodiment, the database holds information on senders who have a spam history, causing the email to be blocked. The invention is distinguished from conventional approaches which rely only on IP addresses.

The invention comprises transmitting the set of email parameters (sender domain or sender email address and the IP address of the sending email host) and receiving a status from a database. In an embodiment, concatenating the domain and IP address as labels to a RBL-like query elicits a status from a database.

### ADVANTAGEOUS EFFECTS

The method of transmitting a query is efficient and avoids limitations in access into or out of networks. The method of replying to a query allows data to be cached close to the user.

The method facilitating email transmission uses a centralized database and does not depend on wide-spread adoption of a policy. No further effort on the part of a well-behaved email sender is required to establish his good reputation. Well-behaved email senders who share an email client used by spammers would not be penalized by having their mail blocked. The benefit of the invention is in reducing the load on spam scanners and expediting delivery of mail from legitimate email senders. By transmitting the query as a fully qualified domain name and receiving the response as an IP address, the result is cached in the distributed domain name system.

### DESCRIPTION OF DRAWINGS

FIG. 1 is a block diagram of a dns system.

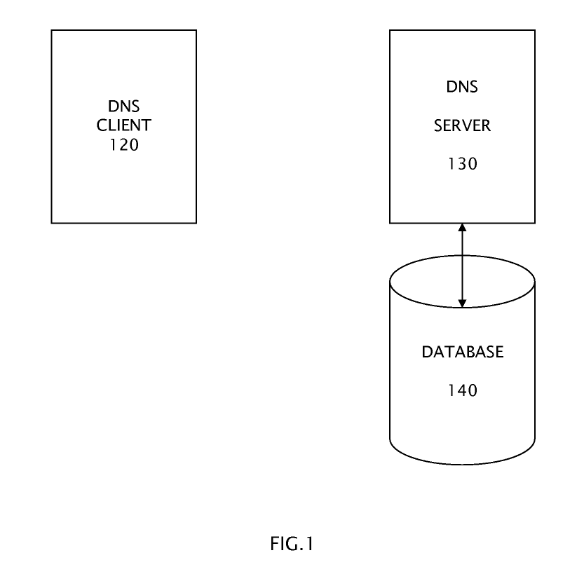

FIG. 2 is a flow chart of email entering the system.

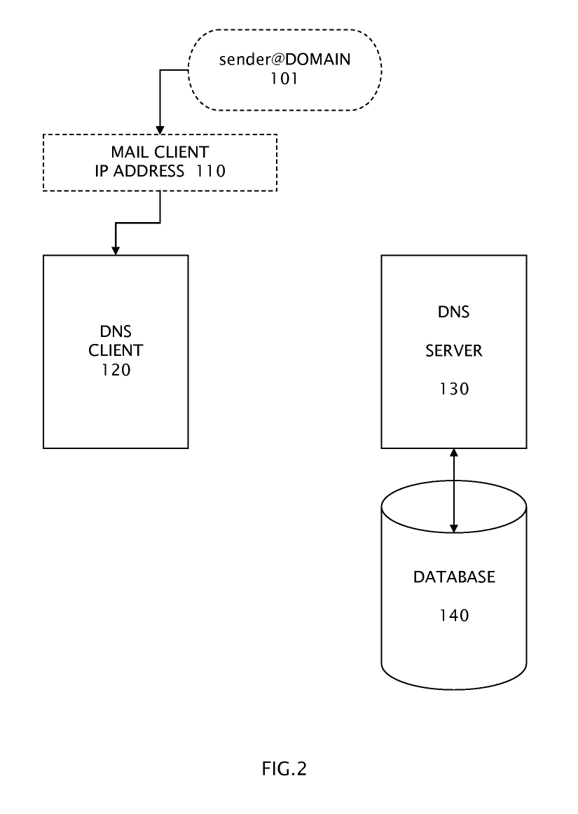

FIG. 3 is a flow chart of a query within the dns system.

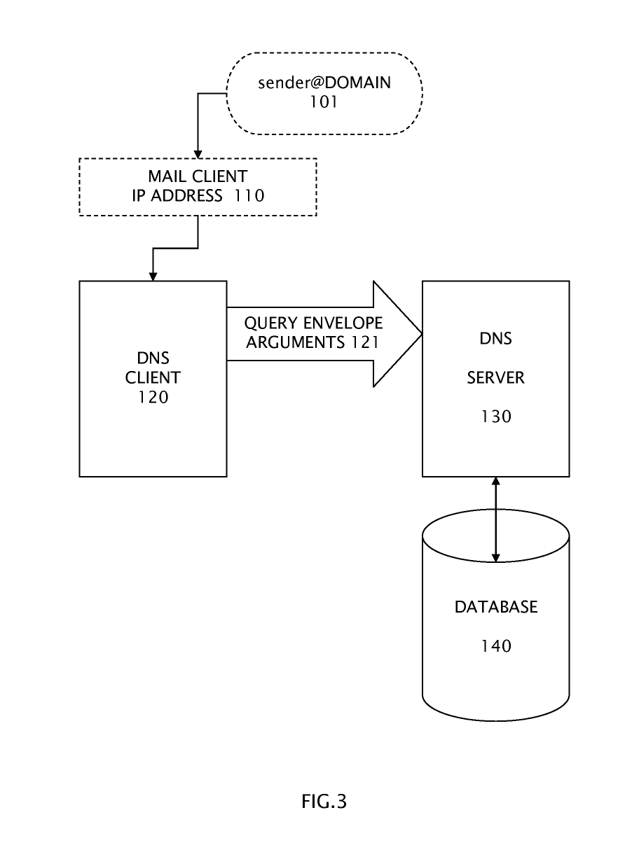

FIG. 4 is a process flow of email through the system.

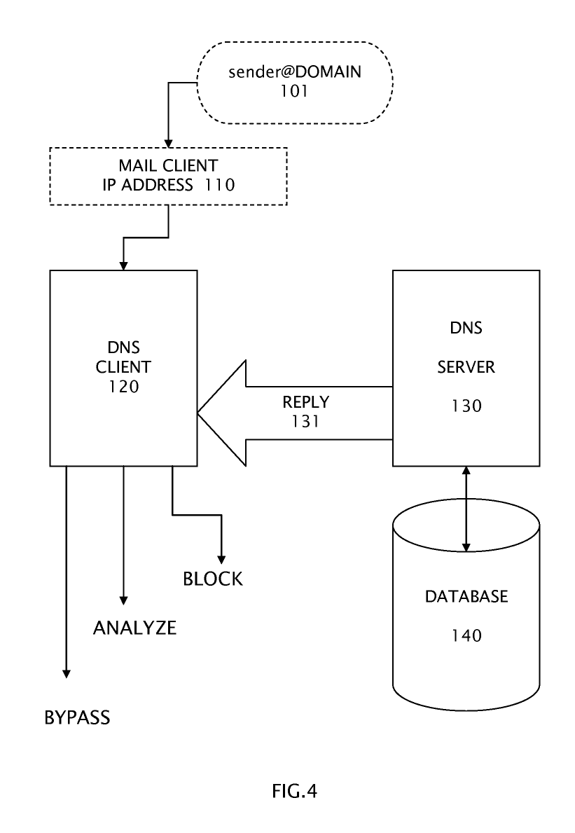

### DETAILED DISCLOSURE OF QUERY CLIENT

The present application discloses a method for querying a database located on a network comprising:

concatenating a plurality of query arguments;

prepending the query arguments to a suffix to form a fully qualified domain name (FQDN) wherein a suffix is a dns server host; and

sending a query on the FQDN in a domain name system (DNS).

More specifically the method for querying a database at a website has the following steps:

sending a dns request of class=IN;

concatenating a suffix of the website to a plurality of query arguments to form a string formatted as a fully qualified domain name,

sending dns queryname=the fully qualified domain name to a domain name system; and

receiving at least one data value encoded within an IP address format as a dns query response from the domain name system,

wherein a fully qualified domain name comprises a plurality of labels separated by dots and ending with a domain, a top level domain and a dot.

The method further comprises sending a dns request selected from the following: type=A, type=AAAA, type=spf, type=CNAME, and type=TXT.

In an embodiment the IP address is one of two to the 32 power unique values of the IPv4 system (four octets).

In an embodiment the IP address is one of two to the 128 power unique values of the IPv6 system (eight groups of 4 hexadecimal digits).

The method further comprises steps storing the dns query response in cache in a distributed domain name system and serving to a dns resolver.

The IP address may represent one of a subjective probability on a scale, an action suggested, and a degree of additional handling.

By a plurality of query arguments we mean at least a first query term and a second query term separated by a dot.

In the present invention an IP address comprises a plurality of groups separated by dots wherein groups are one of binary numbers, decimal numbers, hexadecimal numbers and octal numbers.

The invention further supports access control by using a query argument for an authentication code, whereby billing records may be checked or updated and users of the database may be validated or rejected.

### Detailed Disclosure of Email Sender Reputation Checking

One aspect of the invention is a method for filtering an email between a Simple Mail Transfer Protocol (SMTP) client and a SMTP server the method comprising:
receiving a sequence of SMTP commands up to and including a MAIL command,
withholding an SMTP reply code after receiving the MAIL command,
determining a plurality of email parameters extracted from elements of the SMTP commands received up to and including the MAIL command,
appending a certain suffix to at least two email parameters concatenated in any order to form a query string,
querying a reputation server before transmitting an SMTP reply code after the MAIL command, and
facilitating transmission of the email according to a reply from the reputation server, wherein facilitating transmission comprises bypassing any additional filtering whereby email is transmitted to a recipient when the email parameters match that of a sender without a history of sending spam.

In an embodiment, determining a plurality of email parameters comprises the steps

extracting a sender email address from an SMTP MAIL command and

extracting a client IP address from an IP packet header of the SMTP MAIL command. In an embodiment, determining a plurality of email parameters from an SMTP session comprises the steps

extracting a client domain and

extracting a client IP address

from an IP packet header of a command the client normally sends to a server, indicating the client's identity to open an SMTP session. Non-limiting exemplary commands include but are not limited to HELO and EHLO. It is understood that the Internet Engineering Task Force may specify equivalent commands with different names and extended functionality which are equivalent to HELO and EHLO for our needs.

An other aspect of the invention is a method for filtering an email transmitted from a Simple Mail Transfer Protocol (SMTP) client, the method comprising

receiving from a mail client an SMTP sequence up to and including a MAIL command,

withholding an SMTP reply code after receiving the MAIL command,

determining a plurality of email parameters extracted from elements of SMTP commands received up to and including the MAIL command,

appending a certain suffix to at least two email parameters concatenated in any order to form a query string,

transmitting said query string in the form of a domain name system request to reputation server configured as a domain name system server,

receiving a reply from said reputation server, said reply in the form of an IP address whereby some variable information about the email parameters is encoded within the IP address format, and

facilitating transmission of the email according to the reply from the reputation server, wherein facilitating transmission comprises bypassing any additional filtering whereby the email is transmitted to a recipient when its email parameters match that of a sender without a history of sending spam;

or transmitting a permanent error status reply code after the MAIL command to terminate the SMTP session when the email parameters match that of a sender with a history of sending spam.

The present invention is a method for facilitating email delivery comprising extracting email parameters, querying a database of well behaved senders, receiving a reply based on the reputation of an email sender, and processing the email according to the reply.

In an embodiment the invention is a method for facilitating email delivery comprising extracting email parameters, querying a database of senders, receiving a reply based on the reputation of an email sender, and blocking the email from propagation when the email parameters match those of a spammer.

In an embodiment the invention is a method for facilitating email delivery comprising extracting email parameters, querying a database of well behaved senders, receiving a reply based on the reputation of an email sender, and setting a score on the email for further analysis when the email parameters do not match those of a legitimate sender.

In an embodiment the invention is a method for facilitating email delivery comprising extracting email parameters, querying a database of well behaved senders, receiving a reply based on the reputation of an email sender, and bypassing any additional filtering whereby email is transmitted to the recipient when the email parameters match those of a legitimate sender.

Specifically, the invention is a method for querying a database comprising the following steps:

sending a dns request of class=IN;

concatenating a suffix of the domain name of the database to a plurality of query arguments to form a string formatted as a fully qualified domain name,

sending dns queryname=the fully qualified domain name; and

receiving data as a dns query response, wherein a fully qualified domain name comprises a plurality of labels separated by dots and ending with a domain, a dot, and a top level domain, wherein a first query argument is a domain of an email sender and a second query argument is a hostid of an email sender wherein a hostid is an IP address and wherein the dns request type is selected from the group A, AAAA, TXT, CNAME, and SPF.

In an embodiment the invention supports filtering email between an smtp client and an smtp server wherein smtp is simple mail transfer protocol, the method comprises

forming at least one set of email parameters from an smtp session,

querying a reputation server before completing the smtp session, and

facilitating transmission of the email according to the reply from the reputation server.

In an embodiment forming a set of email parameters from an smtp session means the steps of extracting a sender email address from an smtp mail command and extracting a smtp client IP address from an IP header of the smtp session.

In an embodiment the data received in response to a DNS query comprises a first IP address if there is a match and a second IP address if there is not a match within the database server.

In an embodiment, querying a database comprises appending a certain suffix to a string and querying a domain name system wherein a string comprises at least two envelope arguments concatenated in any order, wherein envelope arguments are selected from the following: a domain, an IP address, and a local-part of an email address.

An email filter embodied as an apparatus or as a process preceding an smtp server may substantially reduce the load on the server by preventing smtp sessions with spammers to reach the point where data is transferred via the server.

The invention may be used to advantageously reduce the load on a spam scanner by preprocessing email. Email that originates from known good senders bypasses the spam scanner entirely.

An embodiment of the invention further reduces the load on a spam scanner by terminating a mail session which been initiated from a set of email parameters of a known spammer in a database containing spammers.

### Method Embodiments in a Computer System

An embodiment of the invention is an article of manufacture comprising computer readable media encoded with instructions to adapt the operation of a processor.

An embodiment of the invention is an apparatus comprising a computing system and the above article of manufacture. An aspect of the invention is an apparatus which comprises a computing system which has inter alia a network interface circuit communicatively coupled to a processor and a non-transitory computer readable media encoded with instructions to adapt the operation of the processor:

to facilitate transmission of an email according to a reply from a reputation server, wherein facilitation of transmission comprises bypassing any additional filtering whereby the email is transmitted to a recipient when its email parameters match that of a sender without a history of sending spam. An other aspect of the apparatus comprises encoded instructions to transmit a permanent error status reply code after the MAIL command to terminate the SMTP session when the email parameters match that of a sender with a history of sending spam. In an embodiment the apparatus further comprises a circuit to receive a reply from a reputation server, said reply in the form of an IP address whereby some variable information about email parameters is encoded within the IP address format. In an embodiment the apparatus further comprises a circuit to transmit, in the form of a domain name system request, at least two email parameters concatenated in any order to form a query string. In an embodiment the apparatus further comprises a circuit communicatively coupled to a wide area network to receive from a Simple Mail Transfer Protocol client a sequence of SMTP commands and withhold a reply code to a MAIL command. In an embodiment the apparatus further comprises a circuit to analyze the contents of SMTP commands received from an SMTP client up to and including a MAIL command; to extract a plurality of email parameters from said commands, and prior to receiving a DATA command, to form a query string by concatenating a certain suffix to at least two email parameters. In an embodiment, an email parameter is one of a domain name and an Internet Protocol address wherein the email parameter is not within a body of an email

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

### CONCLUSION

The present invention is distinguished by concatenating a plurality of query arguments into a string with a suffix to form a fully qualified domain name. The present invention is distinguished by sending a query with a plurality of arguments to a domain name system. The present invention is further distinguished by appending an authentication code to a query submitted to a domain name system. The present invention is distinguished by matching a plurality of query arguments in a database and replying with a response in the form of query reply. Performance may be improved due to caching of the reply in the domain name system.

The present invention is distinguished from conventional anti-spam filtering methods (which typically block identified spammers) by focussing on identifying legitimate email senders and facilitating transmission of their email with minimum processing. The method assumes the existence of a database generated and managed outside of the scope of the present invention. This database contains the email parameters of email senders who have a history of sending email which is not spam. The present invention is distinguished from conventional systems by preparing, and transmitting a multi-dimensional query in contrast to a uni-dimensional IP address query. The present invention is further distinguished by expediting email through to the receiver when the multi-dimensional query results in a match in the legitimate sender database. Bypassing further filtering consumes less resource and improves prompt delivery rather than adding delay and processing cost.

The present invention relies on a reputation database of email parameters comprising at least email sender domains and associated IP addresses of legitimate email senders. It is well known among those skilled in the art how to compile the information by observing past email.

In an embodiment, the process of the invention comprise extracting both an IP address associated with the email sender and the domain of the sender, concatenating them into a single query, transmitting the query to a reputation database, receiving a match, and facilitating the transmission of the email according to the result.

It is the objective of the present invention to recognize the good behavior of email senders in a reputation advisor which distinguishes them from spam operators without burdening them with addition tasks in signing or authenticating their mail and systems. And in many cases legitimate non-spam senders do not control access to the mail servers their internet service providers utilize or the fraudulent use of their email addresses by spam senders. The present invention is distinguished from conventional remote block lists which use only IP addresses by using a set of email parameters which provide two, three, or more dimensions.

The present invention comprises an email facilitation apparatus which receives email, formulates a query, receives a reply code and controls the transmission of the email. In an embodiment the method of forming an email parameter query comprises extracting and assembling the domain of an email sender and the host id of the SMTP client employed. The invention further comprises a reputation server apparatus which receives a query and determines and sends a reply code.

The above discussion and description includes illustrations to support the understanding and appreciation of the invention but should be recognized as not limiting the scope which is defined by the claims following.

Significantly, this invention can be embodied in other specific forms without departing from the spirit or essential attributes thereof, and accordingly, reference should be had to the following claims, rather than to the foregoing specification, as indicating the scope of the invention.

We claim:

1. A method for filtering an email between a Simple Mail Transfer Protocol (SMTP) client and a SMTP server the method comprising:
receiving a sequence of SMTP commands up to and including a MAIL command,
withholding an SMTP reply code after receiving the MAIL command,
determining a plurality of email parameters extracted from elements of the SMTP commands received up to and including the MAIL command,
appending a certain suffix to at least two email parameters concatenated in any order to form a query string,
querying a reputation server before transmitting an SMTP reply code after the MAIL command, and
facilitating transmission of the email according to a reply from the reputation server, wherein facilitating transmission comprises bypassing any additional filtering whereby email is transmitted to a recipient when the email parameters match that of a sender without a history of sending spam.

2. The method of claim 1 wherein
determining a plurality of email parameters comprises the steps
extracting a sender email address from an SMTP MAIL command and
extracting a client IP address from an IP packet header of the SMTP MAIL command.

3. The method of claim 1 wherein
determining a plurality of email parameters from an SMTP session comprises the steps
extracting a client domain and
extracting a client IP address
from an IP packet header of a command the client normally sends to a server, indicating the client's identity to open an SMTP session.

4. A method for filtering an email transmitted from a Simple Mail Transfer Protocol (SMTP) client, the method comprising
receiving from a mail client an SMTP sequence up to and including a MAIL command,
withholding an SMTP reply code after receiving the MAIL command,
determining a plurality of email parameters extracted from elements of SMTP commands received up to and including the MAIL command,
appending a certain suffix to at least two email parameters concatenated in any order to form a query string,
transmitting said query string in the form of a domain name system request to reputation server configured as a domain name system server,
receiving a reply from said reputation server, said reply in the form of an IP address whereby some variable information about the email parameters is encoded within the IP address format, and
facilitating transmission of the email according to the reply from the reputation server, wherein facilitating transmission comprises bypassing any additional filtering whereby the email is transmitted to a recipient when its email parameters match that of a sender without a history of sending spam;
or transmitting a permanent error status reply code after the MAIL command to terminate the SMTP session when the email parameters match that of a sender with a history of sending spam.

5. An apparatus comprises a computing system which has inter alia a network interface circuit communicatively coupled to a processor and a non-transitory computer readable media encoded with instructions to adapt the operation of the processor:
to facilitate transmission of an email according to a reply from a reputation server, wherein facilitation of transmission comprises bypassing any additional filtering whereby the email is transmitted to a recipient when its email parameters match that of a sender without a history of sending spam.

6. The apparatus of claim 5 further comprises encoded instructions to transmit a permanent error status reply code after the MAIL command to terminate the SMTP session when the email parameters match that of a sender with a history of sending spam.

7. The apparatus of claim 5 further comprises a circuit to
receive a reply from a reputation server, said reply in the form of an IP address whereby some variable information about email parameters is encoded within the IP address format.

8. The apparatus of claim 5 further comprises a circuit to transmit, in the form of a domain name system request, at least two email parameters concatenated in any order to form a query string.

9. The apparatus of claim 5 further comprises a circuit communicatively coupled to a wide area network to receive from a Simple Mail Transfer Protocol client a sequence of SMTP commands and withhold a reply code to a MAIL command.

10. The apparatus of claim 9 further comprises a circuit to analyze the contents of SMTP commands received from an SMTP client up to and including a MAIL command; to extract a plurality of email parameters from said commands, and prior to receiving a DATA command, to form a query string by concatenating a certain suffix to at least two email parameters.

11. The apparatus of claim 10 wherein an email parameter is one of a domain name and an Internet Protocol address wherein the email parameter is not within a body of an email
